(19) United States
(12) Patent Application Publication
(10) Pub. No.: US 2009/0252019 A1
(43) Pub. Date: Oct. 8, 2009

(54) MICRO OPTICAL PICKUP APPARATUS

(75) Inventors: Cheng-Huan Chen, Taoyuan (TW); Ya-Ni Su, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: National Chiao Tung University, Hsinchu City (TW)

(21) Appl. No.: 12/405,148

(22) Filed: Mar. 16, 2009

(30) Foreign Application Priority Data
Apr. 3, 2008 (TW) 097112391

(51) Int. Cl. G11B 7/135

(52) U.S. Cl. 369/112.16; G9B/7.112

(57) ABSTRACT

This invention discloses a micro optical pickup apparatus for providing an incident light to an optical recording medium, receiving a reflected light from the optical recording medium, and thereby accessing data of the optical recording medium. The micro optical pickup apparatus includes a light source generating element for producing the incident light, an axial light splitting element allowing the incident light to pass through and deflecting the reflected light according to polarization directions of the incident and reflected lights, a polarization element disposed between the axial light splitting element and the optical recording medium is capable of changing the polarization directions of the incident light and reflected light of the optical recording medium, an astigmatic mirror for receiving, astigmatism focusing and reflecting the reflected light from the axial light splitting element, and an optical sensing element for receiving the reflected light from the astigmatic mirror and converting the reflected light into a corresponding electric signal.

### FIELD

The present invention relates to a micro optical pickup apparatus, and more particularly to a micro optical pickup apparatus using an axial light splitting element and an astigmatic mirror installed separately.

### BACKGROUND

At present, optical disc drives are used extensively in audio/video players and data storage devices, and thus is a necessary computer peripheral. Since optical disc drives become increasingly thinner, the design of an optical pickup head is one of the key points. Optical pickup head is just like the heart of an optical disc drive having a primary function of producing sufficiently small focusing points on an optical disc and generating a focus error signal and a track error signal in order to access data stored in the optical disc accurately and quickly. To reduce volume, some optical pickup heads are made by integrated circuits, and the micro electro-mechanical elements are coupled with each other by a micro electro-mechanical system (MEMS) technology, and a surface micro manufacturing technology is used for reducing the size and weight of a system and showing a micro optical bench and functions of a signal pickup head module of the optical disc drives.

Referring to FIG. 1 for a schematic view of a conventional micro optical pickup apparatus, the micro optical pickup apparatus 1 is made of stacked micro optical elements. The micro optical pickup apparatus 1 includes a laser LED 10, an optical detector 11, a holographic optical element (HOE) 12, a collimating lens 13 and an object lens 14. The laser diode 10 produces an incident light 16 for passing through the holographic optical element 12 and a collimating lens 13 to form parallel beams and then the incident light 16 passes through a object lens 14 for focusing onto an optical disc 15. A reflected light 17 is reflected from the optical disc 15, passes through the holographic optical element 12, and focuses on the optical detector 11.

In the design of a holographic optical element 12, patterns with a deflected angle are etched to achieve one order of the diffracted beams, produce a limited efficiency of optical paths and raise the level of difficulty for the lithographic process. Furthermore, it is necessary to take the stress issue of a thin film into consideration. In the area of micro optical manufacturing processes, etching is one of the important manufacturing processes. With the lithographic process, a pattern is transferred to a photoresist on a thin film, and a portion of the thin film covered and protected by the photoresist is removed by a chemical reaction or a physical action, so as to complete the final purpose of transferring the pattern onto the thin film.

Wet etching is the earliest etching technology used for removing the uncovered portion of a thin film by a chemical reaction between the thin film and a specific solution. The features of the wet etching include a simple manufacturing process, a quick etching speed, and a wide range of different materials. However, the chemical reaction comes with an isotropic etching which is a non-directional etching using corrosive radicals for oxidizing and bonding an etched material, and an equal speed of etching the etched material downward and sideway causes the formation of an undercut easily. On the other hand, dry etching is an anisotropic etching technology used for removing a material by exposing the material to a bombardment of ions, and the high-energy ions go through a bias voltage attraction to accelerate bombarding on a surface of the etched material and dislodge portions of the material from the exposed surface, and thus dry etching has an advantage of controlling a thin film etch profile. Therefore, the fabrication of a holographic optical element 12 requires etching patterns on a thin film at a deflected angle and comes with a narrow range of computation parameters and a high level of difficulty for the control technically.

In addition, the conventional holographic optical element 12 is a penetrating optical element that requires spaces on both sides for the optical transmission and becomes an unfavorable factor for minimizing the thickness of the optical pickup apparatus.

In view of the shortcomings of the prior art, the inventor of the present invention based on years of experience in the related field to conduct extensive researches and experiments, and finally developed a micro optical pickup apparatus of the present invention to overcome the shortcomings of the prior art.

### SUMMARY

The primary objective of the present invention is to provide a micro optical pickup apparatus to solve the problem of having a too-narrow range of parameters for the manufacture and design to lower the level of difficulty for the fabrication of the integrated circuits by means of an axial light splitting element and an astigmatic mirror.

With these and other objects, advantages, and features of the invention that may become hereinafter apparent, the nature of the invention may be more clearly understood by reference to the detailed description of the invention, the embodiments and to the several drawings herein.

To achieve the foregoing objective, the present invention provides a micro optical pickup apparatus for providing an incident light to an optical recording medium, receiving a reflected light from the optical recording medium, and acessing the data of the optical recording medium. The micro optical pickup apparatus comprises a light source generating element for generating the incident light, an axial light splitting element, a polarization element, an astigmatic mirror and an optical sensing element. The axial light splitting element drives the incident light to pass through completely according to the polarization directions of incident light and the reflected light, and deflects the reflected light. The polarization element is installed between the axial light splitting element and the optical recording medium is capable of changing the polarization directions of the incident light and the reflected light from the optical recording medium. The astigmatic mirror is provided for receiving, astigmatism focusing and reflecting the reflected light from the axial light splitting element. The optical sensing element is provided for converting a reflected light from the astigmatic mirror into a corresponding electric signal.

The polarization direction of the reflected light is substantially perpendicular to the polarization direction of the incident light.

The axial light splitting element is preferably a serrated grating or a saw-tooth like grating.

The astigmatic mirror is preferably a continuous cambered surface structure is a binary optical structure or a Fresnel structure.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a schematic view of a micro optical pickup apparatus of a prior art;

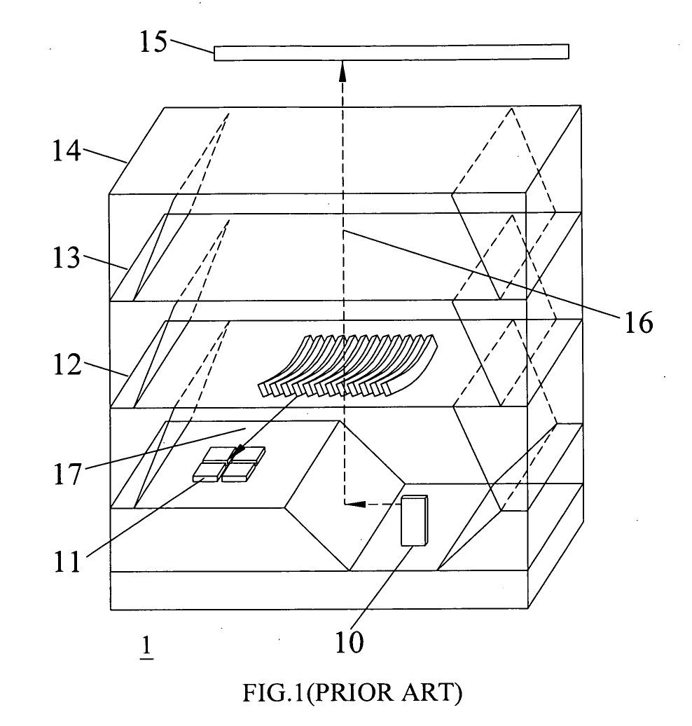

FIG. 2 is a schematic view of a micro optical pickup apparatus of the invention;

FIG. 3 is a schematic view of a micro optical pickup apparatus in accordance with a first preferred embodiment of the invention;

FIG. 4 is a schematic view of a micro optical pickup apparatus in accordance with a second preferred embodiment of the invention;

FIG. 5A shows an example of the shape of a light spot focused on an optical detector of micro optical pickup apparatus in accordance with the invention;

FIG. 5B shows another example of the shape of a light spot focused on an optical detector of micro optical pickup apparatus in accordance with the invention; and

FIG. 5C shows a further example of the shape of a light spot focused on an optical detector of micro optical pickup apparatus in accordance with the invention.

### DETAILED DESCRIPTION

Exemplary embodiments of the present invention are described herein in the context of a micro optical pickup apparatus.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

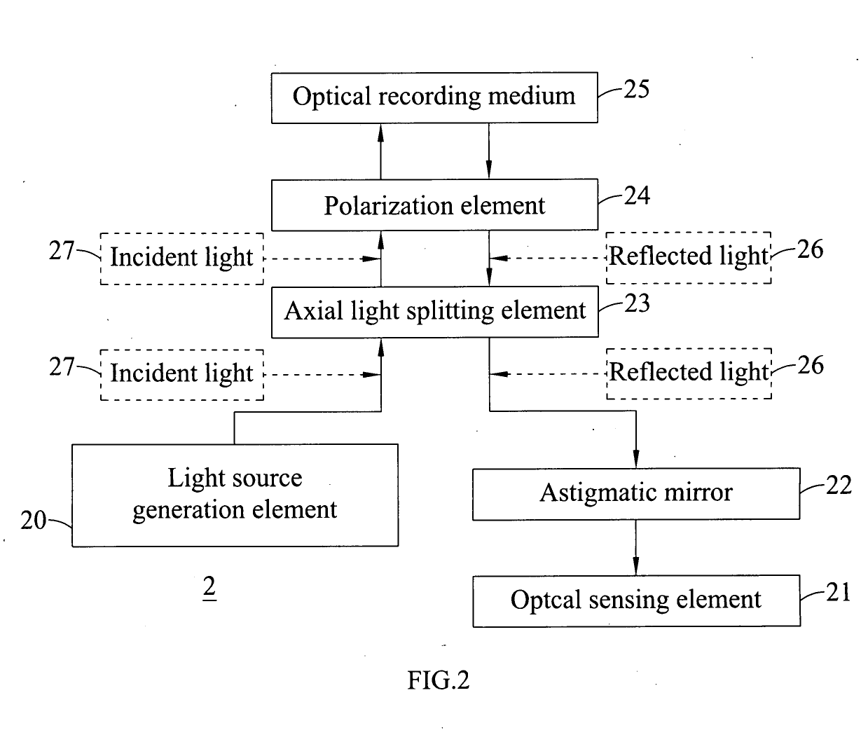

Referring to FIG. 2 for a schematic view of a micro optical pickup apparatus of the invention, the micro optical pickup apparatus 2 is used for reading data of an optical recording medium 25 such as a VCD or DVD disc. The micro optical pickup apparatus 2 comprises a light source generating element 20, a polarization element 24, an axial light splitting element 23, an astigmatic mirror 22 and an optical sensing element 21. The light source generating element 20 is provided for producing an incident light 27 projected towards the axial light splitting element 23. The light source generating element 20 is preferably a laser diode. The axial light splitting element 23 is deflected or passed through directly according to the polarity direction of the incident light 27. In this embodiment, the incident light 27 is passed through the axial light splitting element 23 and projected towards the polarization element 24.

The polarization element 24 is installed between the axial light splitting element 23 and the optical recording medium 25 is capable of changing the polarization direction of the incident light 27. The incident light 27 is passed through the polarization element 24 and projected to the optical recording medium 25, and the incident light is reflected to produce a reflected light 26 from the optical recording medium 25 to the polarization element 24. With the action of the polarization element 24, the polarization directions of the reflected light 26 and the incident light 27 are different, so that the reflected light 26 is deflected towards the astigmatic mirror 22 when the reflected light 26 is projected onto the axial light splitting element 23.

The astigmatic mirror 22 astigmatism focuses and reflects the reflected light 26 to the optical sensing element 21. The optical sensing element 21 includes a plurality of independent sensing areas disposed on the optical path of the astigmatic mirror 22 for receiving the reflected light 26 from the astigmatic mirror 22 and detecting the intensity of the reflected light 26 to generate a corresponding electric signal. The reflected light 26 forms a light spot on the optical sensing element 21, and the shape of the light spot varies with a change of the position of the optical recording medium 25, and thus all independent sensing areas of the optical sensing element 21 can be used for sensing the light intensity signals to compute a change of position of the optical recording medium 25.

The incident light produced by the light source generating element 20 is projected towards the optical recording medium 25. After the incident light is reflected from the optical recording medium 25, the reflected light is astigmatism focused onto the optical sensing element 21 by the astigmatic mirror 22 to form a light spot. The optical recording medium 25 shakes vertically up and down due to its operation, such that the light spot produces an asymmetric structural change. The change of the light dot can be analyzed to produce an error signal. The polarization element 24 is a retarder such as a ¼ phase delay wave-plate, a polarizer or any optical element capable of rotating the polarization direction of the reflected light to provide a different polarization direction of the incident light 27.

The axial light splitting element 23 is preferably an optical element made of a combination of an isotropic material and an anisotropic material, such as a serrated grating or a saw-tooth like grating. In the manufacture of the grating, an isotropic material is used to form a serrated element or a step-shape tooth-like element, and then the anisotropic material is covered onto the isotropic material to form the serrated grating or the saw-tooth like grating. Since the refractive index of the anisotropic material varies with the polarization direction, therefore if the refractive indexes of the isotropic material and the anisotropic material in the polarization direction of the incident light 27 are equal, the incident light 27 can be passed directly. If the polarization direction of the reflected light 26 and the polarization direction of the incident light 27 are different due to the action of the polarization element 24 and the refractive indexes of the isotropic material and the anisotropic material in the polarization direction of the reflected light 26 are different, then the reflected light will be deflected at the grating, and the deflection angle and the grating cycle are related to the angle or slope of the serrated groove of the grating.

The micro optical pickup apparatus 2 is preferably a free space stacked optical sensing device, and includes a reflecting surface for deflecting the aforementioned optical path. The astigmatic mirror 22 can be a continuous cambered surface structure, a binary optical structure or a Fresnel structure. The Fresnel structure is a piecewise continuous structure, and the binary optical structure is a step-type structure, with a thickness smaller than the conventional mirror structure for manufacturing any profile of a non-spherical lens, but the light emitting efficiency is lower. In addition, the astigmatic mirror 22 can be axially symmetric or axially asymmetric, and the cambered surface can be in a cylindrical shape.

Since the micro optical pickup apparatus of the invention uses the astigmatic mirror for the focusing function, and the astigmatic mirror can be installed on another component as needed, and the conventional penetrating holographic optical element requires a space disposed on both sides for optical transmissions. Obviously, the manufacturing process of the invention is able to produce a relatively thinner optical sensing element device.

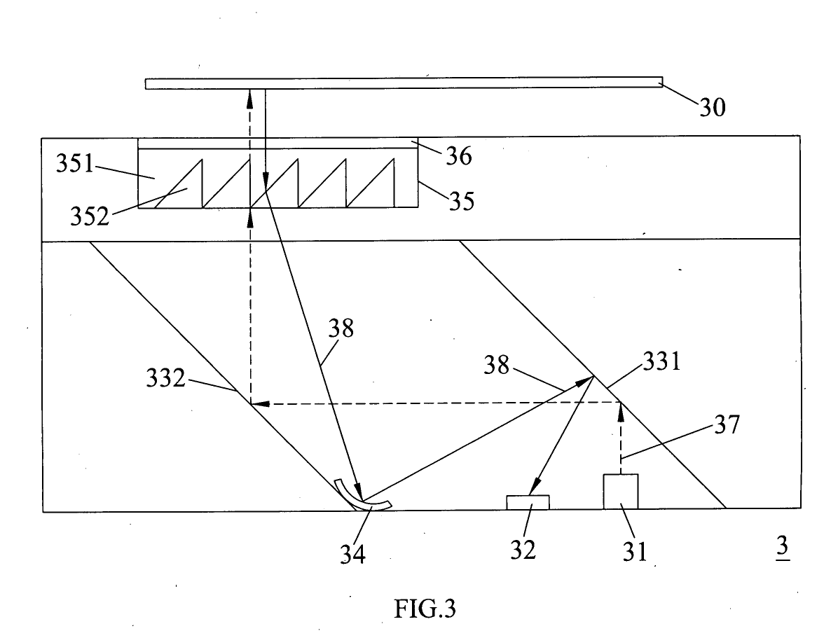

Referring to FIG. 3 for a schematic view of a micro optical pickup apparatus in accordance with a first preferred embodiment of the present invention, the micro optical pickup apparatus 3 is formed on a silicon-based silicon nitride, and a chip packaging technology is used for stacking and packaging, and a computer simulation is used for defining the required specification of the optical element to form a pattern of each optical element onto a mask, and finally a lithography and an etch are used for transferring the pattern onto the optical element to complete producing the free space stacked micro optical pickup apparatus. The micro optical pickup apparatus 3 comprises an optical recording medium 30, a laser LED 31, an optical sensing element 32, a first reflecting surface 331, a second reflecting surface 332, an astigmatic mirror 34, a serrated grating 35 and a ¼ phase delay wave-plate 36.

The incident light 37 produced by the laser diode 31 is reflected from the first reflecting surface 331 and the second reflecting surface 332 to the serrated grating 35. The serrated grating 35 is made of an isotropic material 351 and an anisotropic material 352. In this embodiment, the refractive indexes of the isotropic material 351 and anisotropic material 352 in the polarization direction of the incident light 37 are designed to be equal, and thus the incident light 37 can be passed directly through the ¼ phase delay wave-plate 36 and projected towards the optical recording medium 30. The optical recording medium 30 is provided for reflecting the incident light 37 to generate a reflected light 38.

Since the polarization direction of the reflected light 38 is substantially perpendicular to the polarization direction the incident light 37 after the reflected light 38 is passed through the ¼ phase delay wave-plate 36 again, and the refractive indexes of the isotropic material 351 and anisotropic material 352 in the polarization direction of the incident light 38 are designed to be different, so that the reflected light 38 at the interception of the isotropic material 351 and the anisotropic material 352 is deflected and projected towards the astigmatic mirror 34. The reflection angle of the reflected light 38 is related to the cycle of the grating 35 and the angle of the serrated groove of the grating 35. Designers of the micro optical pickup apparatus can adjust the cycle of the grating and the angle (or slope) of the serrated groove to design the required deflection angle. The reflected light 38 is received by the astigmatic mirror 34, and then astigmatism focused and reflected to the optical sensing element 32 to produce an asymmetric varying light spot.

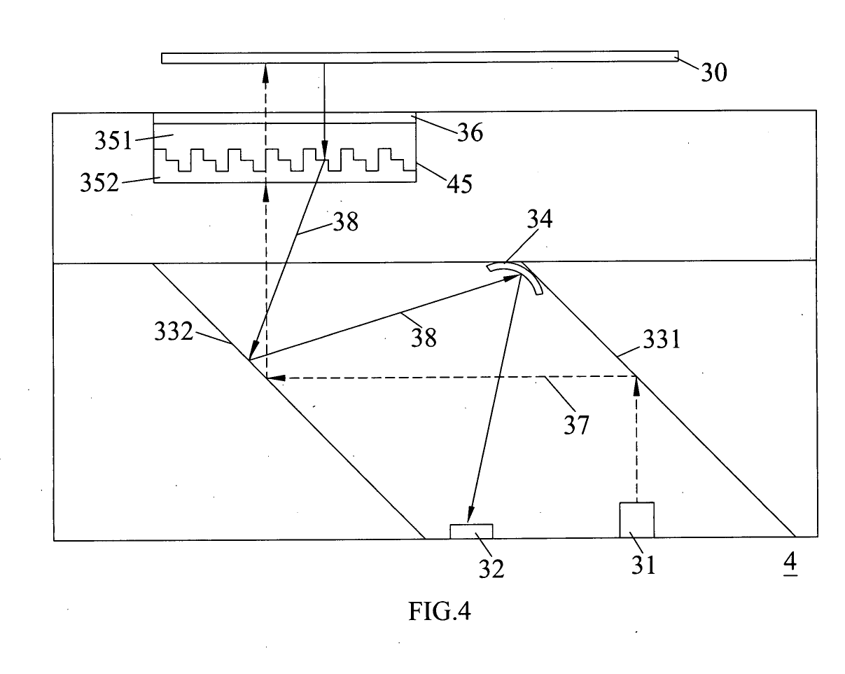

Referring to FIG. 4 for a schematic view of a micro optical pickup apparatus in accordance with a second preferred embodiment of the present invention, the difference of the micro optical pickup apparatus 4 from the micro optical pickup apparatus 3 resides on that the micro optical pickup apparatus 4 uses a saw-tooth like grating 45 as the axial light splitting element, and the astigmatic mirror 34 is installed at a different position for receiving the reflected light 39 deflected at the saw-tooth like grating 45. The saw-tooth like grating 45 is made of a combination of an isotropic material 351 and an anisotropic material 352, and the isotropic material 351 is in a step-shape, and the anisotropic material 352 is covered onto the isotropic material 351. The principle for the saw-tooth like grating 45 to deflect the reflected light 38 is the same as that of the serrated grating 35, and the angle of deflecting the reflected light 38 is related to the cycle of the grating 35 and the slope of the step-shaped groove of the grating 35. After the astigmatic mirror 34 is installed along the deflected optical path of the reflected light 38, the reflected light 38 is astigmatism focused and reflected to the optical sensing element 32. Compared with the serrated grating 36, the saw-tooth like grating 45 requires a higher level of difficulty of the manufacturing process and a lower cost, but gives a lower light emitting efficiency of the serrated grating 36, and thus designers of the micro optical pickup apparatus can select an appropriate axial light splitting element according to the actual requirements.

In the two preferred embodiments, the axial light splitting element is implemented by a grating made of a combination of an isotropic material and an anisotropic material, and both of the incident light incident from a side of the anisotropic material to the grating and the reflected light incident from a side of the isotropic material to the grating are deflected in the grating. However, the invention is not limited to these embodiments only, but any optical element having a different deflection angle of the incident light varied with a different polarization direction of the incident light is intended to be covered by the scope of the present invention.

The design of the micro optical pickup apparatus in accordance with the aforementioned embodiments of the invention can be changed as needed. For instance, the axial light splitting element can be adjusted to change the deflection angle of the axial light splitting element, the position of the astigmatic mirror 34 or the structural form of the astigmatic mirror 34. Further, designers can optimize the efficiency and performance of the axial light splitting element and the astigmatic mirror to improve the efficiency and performance of the micro optical pickup apparatus. Compared with the conventional holographic optical element, the design of the present invention can adopt more flexible parameters and improve the feasibility of the present invention.

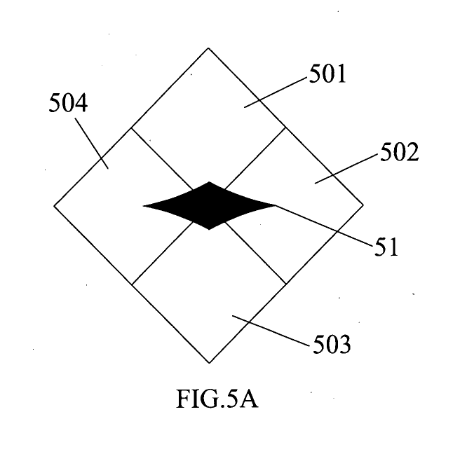

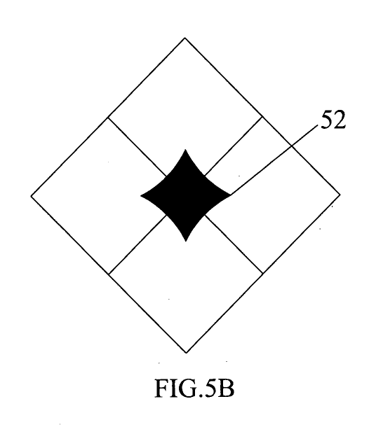

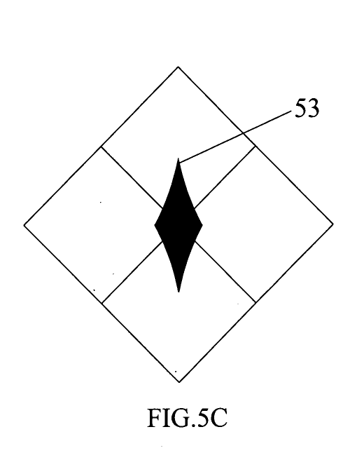

Referring to FIGS. 5A to 5C for the schematic views of the shape of a light spot focused on an optical detector when the focus point is removed from a distant position to a near position, the reflected light is astigmatism focused onto the optical sensing element to form light spots 51˜53 after the reflected light is astigmatism focused by the astigmatic mirror. The optical sensing element includes a plurality of sensing areas 501˜504 for detecting the light intensities of the light spots 51˜53 respectively, converting the light intensities into corresponding electric signals, and using the light intensity signals outputted by the sensing areas 501˜504 to compute a change of position of the optical recording medium.

For instance, if the total light intensity at the sensing area 502 and the sensing area 504 is greater than the total light intensity of the sensing area 501 and the sensing area 503 and exceeds a threshold value, or the shape of the light spot looks very similar to the light spot 51, it means that the focus point is too far. If the total light intensity at the sensing area 501 and the sensing area 503 is greater than the total light intensity of the sensing area 502 and the sensing area 504 and exceeds a threshold value, or the shape of the light spot looks very similar to the light spot 53, it means that the focus point is too close. If the light intensities of the sensing areas 501˜504 are similar, the shape of the light spot looks very similar to the light spot 52, and it means that the reflected light is focused on optical sensing element.

Since the present invention uses an astigmatic mirror for astigmatism focusing a reflected light, a light spot formed on the optical sensing element is in a diamond-like shape instead of the conventional oval shape. With the aforementioned computation, the effect of determining a change of the position of the optical recording medium can be achieved.

From the description above, the micro optical pickup apparatus has the following advantages:
(1) Compared with the conventional holographic optical element, the micro optical pickup apparatus of the invention adopts separately installed axial light splitting element and astigmatic mirror, and thus the level of difficulty of manufacturing the integrated circuit element is lower, and the manufacturing cost can be reduced accordingly.
(2) The micro optical pickup apparatus of the invention can optimize the efficiency and performance of the axial light splitting element and the astigmatic mirror to improve the efficiency and performance of the micro optical pickup apparatus. Compared with the conventional holographic optical element, the design and manufacture of the invention can use more flexible parameters to improve the feasibility of the invention.
(3) The micro optical pickup apparatus of the invention uses the astigmatic mirror for the focusing purpose. Compared with a conventional penetrating holographic optical element, the invention is more favorable to the manufacture of a thin optical sensing element device.

In summation of the above description, the present invention herein enhances the performance than the conventional structure and further complies with the patent application requirements and is thus duly filed for patent application. While the invention has been described by means of specific embodiments, numerous modifications and variations could be made thereto by those skilled in the art without departing from the scope and spirit of the invention set forth in the claims.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A micro optical pickup apparatus, for providing an incident light to an optical recording medium, receiving a reflected light from the optical recording medium, and thereby accessing data of the optical recording medium, the micro optical pickup apparatus comprising:
a light source generating element producing the incident light;
an axial light splitting element allowing the incident light to pass through completely and deflecting the reflected light according to polarization directions of the incident light and the reflected light;
a polarization element, disposed between the axial light splitting element and the optical recording medium, capable of changing the polarization directions of the incident light and the reflected light of the optical recording medium;
an astigmatic mirror receiving, astigmatism focusing and reflecting the reflected light from the axial light splitting element; and
an optical sensing element receiving the reflected light from the astigmatic mirror, and converting the reflected light into a corresponding electric signal.

2. The micro optical pickup apparatus of claim 1, wherein the polarization direction of the reflected light is substantially perpendicular to the polarization direction of the incident light.

3. The micro optical pickup apparatus of claim 1, wherein the axial light splitting element is made of a combination of an isotropic material and an anisotropic material.

4. The micro optical pickup apparatus of claim 1, wherein the axial light splitting element is a serrated grating or a saw-tooth like grating.

5. The micro optical pickup apparatus of claim 4, wherein the reflected light is deflected at the axial light splitting element with an angle related to the cycle of the grating and the angle or slope of the serrated groove of the grating.

6. The micro optical pickup apparatus of claim 1, wherein the astigmatic mirror is an axially symmetric structure or an axially asymmetric structure.

7. The micro optical pickup apparatus of claim 1, wherein the astigmatic mirror comes with a spherical surface, a cylindrical surface or a non-spherical surface.

8. The micro optical pickup apparatus of claim 1, wherein the astigmatic mirror is a continuous cambered surface structure, a binary optical structure or a Fresnel structure.

9. The micro optical pickup apparatus of claim 1, wherein the astigmatic mirror astigmatism focuses and reflects the reflected light on the optical sensing element to form a light spot, and the shape of the light spot varies according to the position of the optical recording medium.

10. The micro optical pickup apparatus of claim 9, wherein the optical sensing element includes a plurality of sensing areas for sensing the intensity of the light spot.
